(19) United States
(12) Patent Application Publication
(10) Pub. No.: US 2016/0259030 A1
(43) Pub. Date: Sep. 8, 2016

(54) METHODS, APPARATUSES AND COMPUTER PROGRAM PRODUCTS FOR CALIBRATION OF ANTENNA ARRAY

(71) Applicant: NOKIA TECHNOLOGIES OY, Espoo (FI)

(72) Inventors: XIANJUN JIAO, Beijing (CN); Xin ZHANG, Beijing (CN); Canfeng CHEN, Beijing (CN)

(21) Appl. No.: 15/027,653

(22) PCT Filed: Oct. 16, 2013
(86) PCT No.: PCT/CN2013/085285

§ 371 Date: Apr. 6, 2016

(51) Int. Cl. G01S 3/02; G01S 3/786

(52) U.S. Cl. CPC G01S 3/023; G01S 3/7865

(57) ABSTRACT

Provided are methods, apparatuses, and computer program products for calibrating a direction-finding system in a handheld device. A method is provided, which comprises: displaying instructions for orienting a device such that an image of a calibration source through a camera of the device falls in a designated position on a screen of said device; receiving a signal from said calibration source via an antenna array of the device; calculating an orientation angle between said device and said calibration source based on said image of the calibration source; storing pairs of the signal and the orientation angle at various instances while moving or rotating the device to make the image of the calibration source move along a predefined trajectory displayed on the screen; and calibrating a direction-finding system in the device based on the stored pairs of the signal and the orientation angle.

### FIELD OF THE INVENTION

Embodiments of the present invention generally relate to antenna array/multi-antenna calibration technology, and more specifically, relate to method, system, apparatus, and computer program product for calibrating a direction-finding system in a handheld device.

### BACKGROUND OF THE INVENTION

Modern society has quickly adopted, and become reliant upon, handheld devices for wireless communication. Manufacturers have incorporated various resources for providing enhanced functionality in these handheld devices. Find and Do (FnD) is a technology which offers direction finding ability to handheld devices.

FIG. 1 schematically shows the basic principle of FnD. A handheld device 101 is equipped with an antenna array, which is an example of signal receiver arrays usable in direction finding. The antenna array may receive signals that are processed in accordance with various algorithms to determine the direction towards the source of a target signal.

The direction-finding function requires calibration. Traditional calibration techniques would require the device to be placed in an anechoic chamber where the response to signals from various directions may be measured using a network analyzer and an antenna positioned. As shown in the left part of FIG. 1, response data of the antenna array integrated inside the handheld device 101 is measured and stored inside the device 101 when a calibration signal source (not shown) in different directions in a process of chamber measurement. The response data are signals obtained from each antenna of the antenna array when the device 101 receives a predefined signal (e.g., DF (Direction Finding) packet) from a calibration signal source (not shown). The response data may be noted as C1, C2, C3 . . . CN, where N is the number of angles measured. The predefined angles are noted as A1, A2, A3 . . . AN. Each data may be a complex vector or matrix. It depends on how many antennas and polarizations are measured.

There will also be many signal resources, also generally referred to in the following disclosure as a “tag”. A tag may be attached to a key, book, or any other objects a user wants to find where it is or other device in people's everyday life. These tags and devices can also transmit DF packet which may be the same as used in the chamber calibration measurement.

After the FnD capable device is shipped to a consumer, the consumer may use the device to find out the direction of other tags/devices which can transmit DF packet. Basically the direction is found by correlating received signals in real world with response data of all directions recorded inside the device in the chamber measurement. Actually the direction is found out by finding which direction's response data generates the highest correlation value with current received signal. For example, as shown in the right part of FIG. 1, the FnD capable device 101 receives a DF packet signal from a tag 102 via its antenna array. The received signal Y is then correlated with response data C1, C2, C3 . . . CN, respectively. If the correlation of Y with Ci generates the maximum correlation value among all the response data, then the direction i (i.e., the angel Ai) associated with the response data Ci is found.

However, one problem comes from the differences between the chamber measurement and real world applications. One difference is in that: there isn't multipath propagation in the chamber, while signal may suffer from multipath in the real world especially in an in-door environment. In other words, the response data measured in the chamber doesn't match the signal collected in the real world perfectly. Another difference is in that: there isn't handheld effect in the chamber, while in the real world, the device may be held in human hands in diverse manners. The human body/hand, which is very close to the antenna array of the device, may change the pattern of the antenna array, thus change the response data eventually. Because of the differences between the chamber and the real world, the accuracy of direction finding of the device may be degraded in the real world. In the worst case, a fake direction may be prompted to FnD users.

Moreover, an FnD capable device may require additional calibration post-manufacture due to some other reasons. For example, devices may experience a variety of conditions on the way to an end consumer such temperature extremes, impact, magnetic or electrical fields, etc. Further, even after a user begins to utilize a device, the performance characteristics of electronic components that support the direction-finding function may change due to use, age, shock, temperature, exposure or simple due to malfunction.

As a result, devices including a signal-based direction-finding system, even in normal use, may require occasionally recalibration.

### SUMMARY OF THE INVENTION

A consumer performed response data measurement in the real world is one way to overcome the above problem. In the following, this “response data measurement in the real world” process is called as “calibration”.

The above and other problems are generally solved or circumvented, and technical advantages are generally achieved, by embodiments of the present invention, which include methods, apparatuses, and computer program products for calibrating a direction-finding system in a handheld device.

According to one aspect of the present invention, a method is provided, which comprises displaying instructions for orienting a device such that an image of a calibration source (may be a tag) through a camera of the device falls in a designated position on a screen of the device; receiving a signal from the calibration source via an antenna array of the device; calculating an orientation angle between the device and the calibration source based on the image of the calibration source; storing pairs of the signal and the orientation angle at various instances while moving or rotating the device to make the image of the calibration source move along a predefined trajectory displayed on the screen; and calibrating a direction-finding system in the device based on the stored pairs of the signal and the orientation angle.

In some embodiments, the method further comprises an initialization process which includes: determining the calibration source; storing an image of the calibration source; and sending a calibration request to the calibration source, to make the calibration source enter a calibration mode where the calibration source transmits the signal (e.g., DF packet) at a high rate.

In further embodiments, calibrating a direction-finding system in the device based on the stored pair of the signal and the orientation angle may comprise: creating a matrix of calibration values in the device using the stored pairs of the signal and the orientation angles, said matrix comprising calibration signals which correspond to a set of designated orientation angles and are generated from the stored pairs of the signal and the orientation angles.

In an additional embodiment, the method may further comprise: during moving or rotating the device, tracking an actual moving trajectory of the image of the calibration source on the screen by using a pre-stored image of the calibration source; checking whether a distance from the actual moving trajectory to the predefined trajectory exceeds a distance threshold; and in response to the distance exceeding the distance threshold, providing an alert. In some implementations, the alert could be implemented as audible, visible, and/or tactile signal. For example, a text box or a bulls-eye target can be shown to prompt a user of the device, or the form, size or color of the predefined trajectory and/or the actual moving trajectory could be changed in some ways to prompt the user of the device. Alternatively or additionally, a beeping sound or vibration could be provided.

In a further additional embodiment, the method may further comprise: during moving or rotating the device, checking whether a moving speed of the image of the calibration source exceeds a speed threshold, and in response to the moving speed exceeding the speed threshold, providing an alert. Similarly, the alert could be implemented as audible, visible, and/or tactile signal.

In some embodiments, there is provided a method for checking whether a direction-finding system of a device needs calibration prior to the calibration of the device. The method comprises: displaying a real-time position of a signal source on a screen of the device through a camera of the device; marking a calculated position of the signal source on the screen, the calculated position being determined by the direction-finding system of the device based on a signal received from the signal source; and in response to an offset between the real-time position and the calculated position exceeding an offset threshold, deciding that the device needs calibration.

In some embodiments, the predefined trajectory includes one-dimensional trajectory or two-dimensional trajectory, and the orientation angle includes at least one of an azimuth angle and an elevation angle.

According to another aspect of the present invention, an apparatus is provided, which comprises at least one processor and at least one memory including computer program code. The at least one memory and the computer program code are configured to, with the at least one processor, cause the apparatus at least to display instructions for orienting a device such that an image of a calibration source through a camera of the device falls in a designated position on a screen of the device; receive a signal from the calibration source via an antenna array of the device; calculate an orientation angle between the device and the calibration source based on the image of the calibration source; store pairs of the signal and the orientation angle at various instances while moving or rotating the device to make the image of the calibration source move along a predefined trajectory displayed on the screen; and calibrate a direction-finding system in the device based on the stored pairs of the signal and the orientation angle.

According to another aspect of the present invention, an apparatus is provided, which comprises means for displaying instructions for orienting a device such that an image of a calibration source through a camera of the device falls in a designated position on a screen of the device; means for receiving a signal from the calibration source via an antenna array of the device; means for calculating an orientation angle between the device and the calibration source based on the image of the calibration source; means for storing pairs of the signal and the orientation angle at various instances while moving or rotating the device to make the image of the calibration source move along a predefined trajectory displayed on the screen; and means for calibrating a direction-finding system in the device based on the stored pairs of the signal and the orientation angle.

According to another aspect of the present invention, a computer program product is provided, which, comprises computer executable program code recorded on a computer readable non-transitory storage medium. The computer executable program code comprises: code configured to display instructions for orienting a device such that an image of a calibration source through a camera of the device falls in a designated position on a screen of the device; code configured to receive a signal from the calibration source via an antenna array of the device; code configured to calculate an orientation angle between the device and the calibration source based on the image of the calibration source; code configured to store pairs of the signal and the orientation angle at various instances while moving or rotating the device to make the image of the calibration source move along a predefined trajectory displayed on the screen; and code configured to calibrate a direction-finding system in the device based on the stored pairs of the signal and the orientation angle.

According to another aspect of the present invention, a system is provided. The system comprises: a device including at least a direction-finding system, a camera, a screen and an antenna array; and a calibration source. The device is configured to: display instructions for orienting the device such that an image of a calibration source through the camera falls in a designated position on the screen; receive a signal from the calibration source via the antenna array; calculate an orientation angle between the device and the calibration source based on the image of the calibration source; store pairs of the signal and the orientation angle at various instances while moving or rotating the device to make the image of the calibration source move along a predefined trajectory displayed on the screen; and calibrate a direction-finding system in the device based on the stored pairs of the signal and the orientation angle.

According to another aspect of the present invention, a non-transitory computer readable medium with computer program code stored thereon is provided. The computer program code when executed by an apparatus cause it to perform the method according embodiments of the above aspect.

According to certain embodiments of the present invention, an FnD capable device is made adaptive to actual complicated environment easily, which is different from the chamber environment. The proposed user-executable calibration only uses a camera of the device as a sensor to get or calculate the orientation angle, and thus it is easy to use. It needn't any other sensor (such as accelerometer, gyro) to sense attitude and/or direction and/or distance. It only use a user interface (UI) to guide a consumer completing the whole process no matter how the consumer holds/rotates/moves/orientates the device. The proposed calibration is performed without returning to factory. Moreover, the calibration is performed without high accuracy mechanical equipment or robot, which is usually used in the chamber measurement.

Other features and advantages of the embodiments of the present invention will also be understood from the following description of specific embodiments when read in conjunction with the accompanying drawings, which illustrate, by way of example, the principles of embodiments of the present invention.

### BRIEF DESCRIPTION OF THE DRAWINGS

The embodiments of the invention that are presented in the sense of examples and their advantages are explained in greater detail below with reference to the accompanying drawings, in which:

FIG. 1 schematically shows the basic principle of FnD in the prior art;

FIG. 2 shows an example embodiment of a wireless communication device (WCD) in which one illustrative embodiment of the present invention can be implemented;

FIG. 3 shows an exemplary configuration schematic of the WCD as shown in FIG. 2;

FIG. 4 is a flow chart schematically illustrating a method for checking whether an FnD capable device needs calibration according to an embodiment of the present invention;

FIG. 5 schematically shows examples of good state and bad state of an FnD capable device;

FIG. 6 schematically shows an exemplary user interface for initializing calibration according to an embodiment of the present invention;

FIG. 7 is a flow chart schematically illustrating the initialization procedures according to an embodiment of the present invention;

FIG. 8 illustrates an example of a user interface movement prompt and device movement accordance to an embodiment of the present invention;

FIG. 9 is a flow chart schematically illustrating a calibration method according to an embodiment of the present invention;

FIG. 10 schematically shows the principle of camera field-of-view (FOV) based angle calculation according to embodiments of the present invention;

FIG. 11 schematically illustrates an exemplary system in which embodiments of the present invention may be implemented; and

FIG. 12 schematically illustrates exemplary storage media, in which one or more embodiments of the present invention may be embodied.

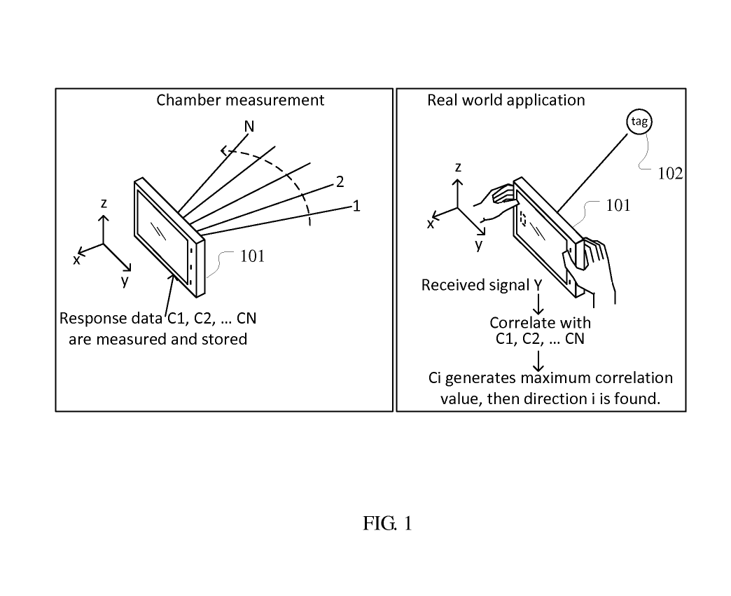

### DETAILED DESCRIPTION OF EMBODIMENTS

Hereinafter, embodiments of the present invention will be described with reference to the accompanying drawings. In the following description, many specific details are illustrated so as to understand the present invention more comprehensively. However, it is apparent to the skilled in the art that implementation of the present invention may not have these details. Additionally, it should be understood that the present invention is not limited to the particular embodiments as introduced here. For example, some embodiments of the present invention are not limited to be implemented in Bluetooth Low Energy (BLE) system. On the contrary, any arbitrary combination of the following features and elements may be considered to implement and practice the present invention, regardless of whether they involve different embodiments. Thus, the following aspects, features, embodiments and advantages are only for illustrative purposes, and should not be understood as elements or limitations of the appended claims, unless otherwise explicitly specified in the claims.

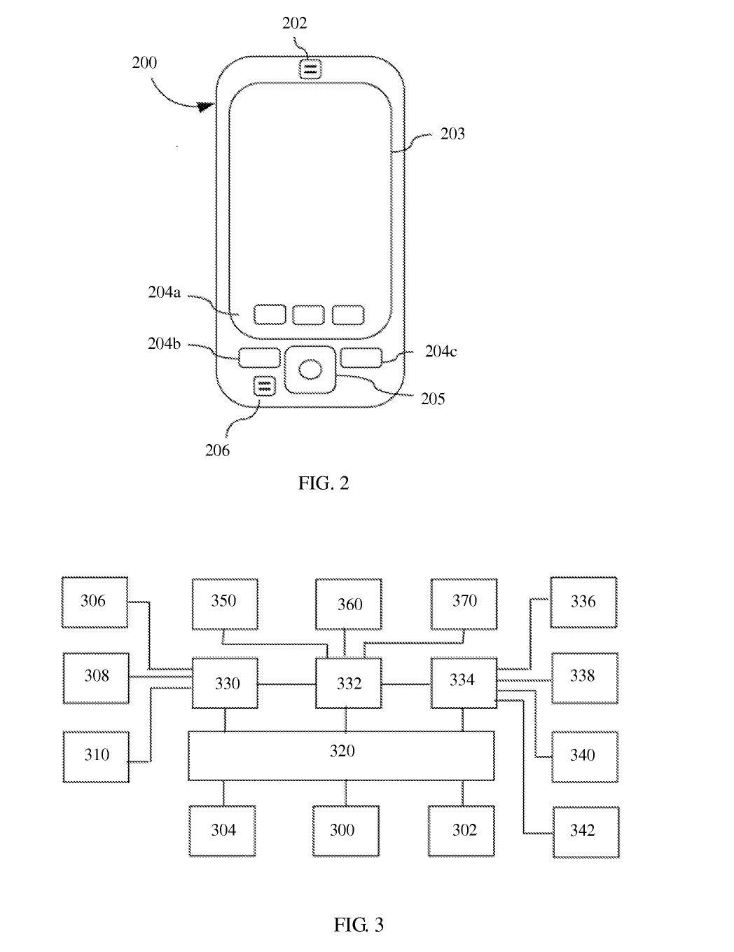

FIG. 2 shows an example embodiment of a wireless communication device (WCD) in which one illustrative embodiment of the present invention can be implemented.

The WCD 200 may comprise a speaker or earphone 202, a microphone 206, a camera (not shown, in the back side of the WCD 200), a touch display 203, a set of keys 204 which may include virtual keys 204a, soft keys 204b, 204c and a joystick 205 or other type of navigational input device, and an antenna array (not shown). It should be noted that, not all components shown are needed for embodiments of this invention to work, such as the speaker 202. FIG. 2 merely shows an exemplary structure of the WCD for the skilled in the art to better understand and further practice the present invention, but not for limiting the scope of the present invention. Of course, the WCD may comprise more components or less components than those shown in FIG. 2.

FIG. 3 shows an exemplary configuration schematic of the WCD as shown in FIG. 2.

The internal component, software and protocol structure of the WCD 200 will now be described with reference to FIG. 3. The WCD has a controller 300 which is responsible for the overall operation of the WCD. The controller 300 may contain a processor which may be implemented by any commercially available CPU (“Central Processing Unit”), DSP (“Digital Signal Processor”) or any other electronic programmable logic device. An example for such controller containing a processor is shown in FIG. 11. The controller 300 has associated electronic memory 302 such as RAM memory, ROM memory, EEPROM memory, flash memory, or any combination thereof. The memory 302 is used for various purposes by the controller 300, one of them being for storing data used by and program instructions for various software in the WCD. The software includes a real-time operating system 320, drivers for a man-machine interface (MMI) 334, an application handler 332 as well as various applications. The applications can include a message text editor 350, a hand writing recognition (HWR) application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, a direction-finding application, etc. It should be noted that two or more of the applications listed above may be executed as the same application.

The MMI 334 also includes one or more hardware controllers, which together with the MMI drivers cooperate with the first display 336/203, and the keypad 338/204 as well as various other I/O devices such as microphone 340, speaker, vibrator, ringtone generator, LED indicator, camera 342, etc. As is commonly known, the user may operate the WCD through the man-machine interface thus formed.

The software can also include various modules, protocol stacks, drivers, etc., which are commonly designated as 330 and which provide communication services (such as transport, network and connectivity) for an RF interface 306, and a Bluetooth interface 308 and/or an IrDA interface 310 for local connectivity. The RF interface 306 comprises an internal or external antenna/antenna array as well as appropriate radio circuitry for establishing and maintaining a wireless link to a base station. As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc

The WCD may also have a SIM card 304 and an associated reader. As is commonly known, the SIM card 304 comprises a processor as well as local work and data memory.

It is important to note that while an exemplary wireless communication device (also referred to as an “FnD capable device”) has been utilized for the sake of explanation in the following disclosure, the present invention is not limited specifically to the disclosed type of device, and may be utilized to calibrate any device including a direction-finding system that operates in a manner similar to those described herein. Example of other devices that may be utilized to implement various embodiments of the present invention are devices that are used primarily for direction finding (such as handheld tracking devices) and any other device enabled to receive and process wireless signal information in order to determine a direction towards, and/or a position of, the signal source.

Before detailed description of various embodiments of the present invention, it should be noted that the terms “signal source”, “tag”, and “beacon” may refer generally to equipments which can transmit, e.g., periodically, DF packet via a wireless link, and thus will be used interchangeably throughout the specification and claims.

As summarized above, embodiments of the present invention propose a consumer-executable solution for calibrating a direction-finding system within an FnD capable device. If an FnD capable device works well, calibration will waste time. Thus, there is a need to check whether an FnD capable device needs calibration. Embodiments herein have provided a method for checking whether an FnD capable device needs calibration prior to calibration.

FIG. 4 is a flow chart schematically illustrating a method for checking whether an FnD capable device needs calibration according to an embodiment of the present invention;

A good FnD capable device can find an object which can transmit DF packet, and mark the direction of the object on the screen. So the user can follow the mark on the screen to find out the object. If the user fails to find the object, then it means calibration may be needed. In embodiments herein, the user can use an in hand signal source/tag to verify if calibration is needed.

As shown in FIG. 4, in step 401, a camera integrated within the FnD capable device is used to acquire a real-time image of an identified signal source or tag. An “identified” tag means that the tag can be confirmed by the user to pair with a tag identified by the FnD capable device based on DF packet received therefrom. The user of the device points the camera at the tag in front of it. Then the tag can be seen on a screen of the device through the camera, and the real-time position of the tag is displayed on the screen.

Meanwhile, in step 402, an antenna array of the FnD capable device receives a signal (i.e., DF packet) from the tag, and a direction-finding system within the device calculates a position of the tag based on a direction-finding algorithm with the DF packet received from the tag. Then, the calculated position of the tag can be marked on the screen.

In step 403, it is determined whether an offset between the real-time position and the calculated position of the tag on the screen exceeds a predefined threshold (which may be denoted as an offset threshold).

If the mark is in an obviously different location compared with the tag in the real-time replay of the camera on the screen, a calibration process should be started. Thus, in step 404, it can be decided that the device needs calibration.

If the offset does not exceed the offset threshold, then the method can go back to step 401, where the user can position or orient the device such that the real-time replay of the tag through the camera falls in another position on the screen. With respect to the new position, the same check (i.e., steps 402-404) may be performed to decide whether the device needs calibration.

Considering errors varying in different directions, the above check may be performed in three typical directions: tag's image falls in right, central, and left area of the screen.

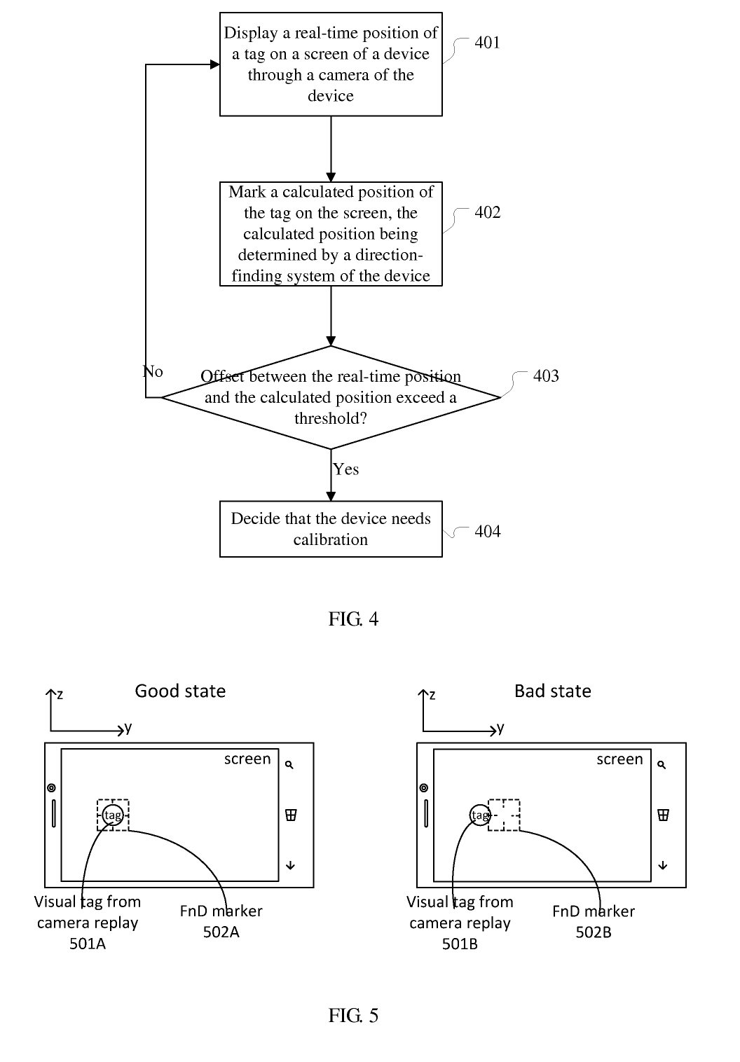

FIG. 5 schematically shows examples of good state and bad state of an FnD capable device.

The left part of FIG. 5 shows an FnD capable device in a good state. The user orients the device such that a tag is put in a place which falls in the Field Of View (FOV) of the camera of the device. As shown, a real-time image 501A of the tag is displayed on the screen. Meanwhile, the direction-finding system of the device makes an FnD mark 502A on a position of the tag which is calculated based on a direction-finding algorithm with a signal (DF packet) received from the tag. In FIG. 5, the FnD mark 502A is shown by a dotted box. It can be understood that the FnD mark 502A can be represented by a mark of other forms (e.g., shape, color, animation, etc.). The real-time image 501A of the tag and the FnD mark 502A are in the same position on the screen, which indicates that the FnD function of the device is in a good state.

The right part of FIG. 5 shows an FnD capable device in a bad state. Also, the user orients the device such that a real-time image 501B of the tag is displayed on the screen. Meanwhile, the direction-finding system of the device makes an FnD mark 502B on a position of the tag which is calculated based on a direction-finding algorithm with a signal (DF packet) received from the tag. As shown, the real-time image 501B of the tag and the FnD mark 502B have an obvious offset therebetween on the screen, which indicates that the FnD function of the device is in a bad state.

If it is determined that an FnD device needs calibration through the check method described above, the user can initiate the calibration process of the FnD device. When a calibration process is performed for the first time, an initiation process may be performed to initialize the calibration.

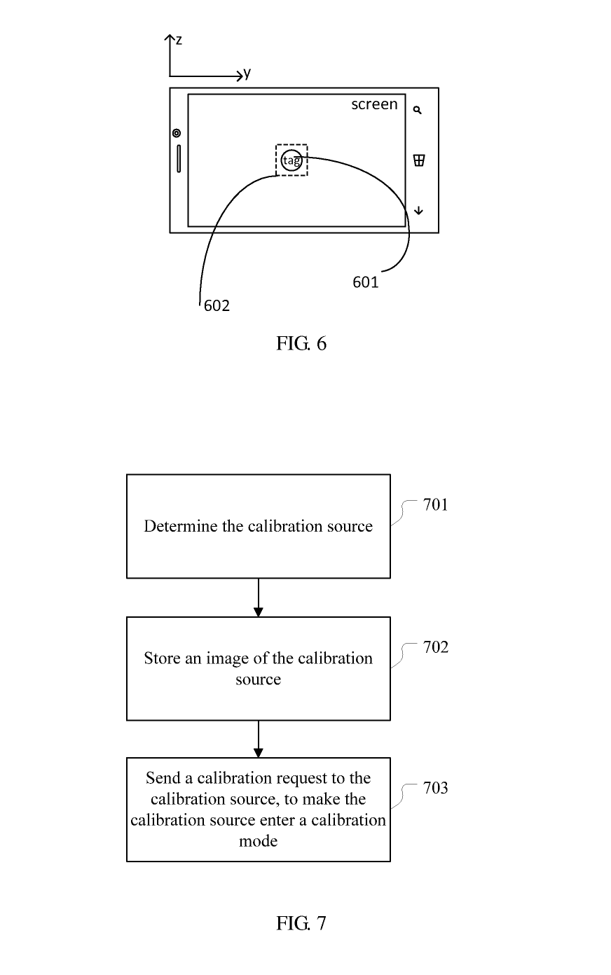

FIG. 6 schematically shows an exemplary user interface for initializing calibration according to an embodiment of the present invention.

The user can make the FnD device into a calibration state by switching its software and firmware state. For example, initially, a user may initiate the calibration process by selecting an option to start a calibration process from a menu in the FnD device. The activation of the calibration may, in accordance with at least one embodiment of the present invention, activate procedures stored in a direction-finding system related to calibration. Alternatively, the activation of calibration may initiate software programs stored in the general memory of the FnD device.

As shown in FIG. 6, the user can adjust the FnD device to make sure that the visual image 601 of a calibration source/tag is in a designated location 602 (e.g. the center) of the screen. The location may be indicated by a user interface (UI) indicator 602 (or central marker) on the screen. The UI indicator 602 on the screen can guide the user adjusting the orientation of the FnD device to towards the calibration source. The calibration source/tag may take different forms in various embodiments of the invention. For example, the calibration source may be a tool used by a supply chain entity (e.g., store, service center or other valued-added provider) in order to calibrate an FnD device before delivery to a customer. In another scenario, the calibration source may be a low-power device supplied to the user along with the FnD device to be utilized specifically for calibration. The calibration source may also be a device to be used along with the FnD device that is sold primarily as a calibration tool or as an accessory such as a key chain. Even a building or other structure with a fixed signal source can be used for calibration. The only requirements for the calibration source are that it should be at least temporarily stationary and able to send a message identifiable by the FnD device as a target signal usable for calibration.

Then, a user input may be received to trigger some initialization procedures. The user input may be implemented by pressing the image 601 of the calibration source on the screen, or by pressing a key of the FnD device or a soft key on the screen, or by a voice command, depending on the configuration of the FnD device. The present invention has no limitation in this regard.

FIG. 7 is a flow chart schematically illustrating the initialization procedures according to an embodiment of the present invention.

First, at step 701, the calibration source/tag should be determined. In other words, the calibration source whose image is presented on the screen should be paired with a signal source identified by the FnD device. Specifically, the FnD device can scan for available calibration sources. Any wireless signal that may be identified as a potential calibration source may be listed on the screen for the user to confirm. The user can get the knowledge of the identification (ID) of the calibration source in advance. For example, the ID may be printed on a surface of the tag. Alternatively, the user can get the ID by Near Field Communication (NFC) with the tag. The FnD device can prompt the user to select the correct calibration source, and record the selected ID as the calibration source in its memory. Alternatively, a tag used for calibration may be specifically identified as calibration source as part of the signal. For example, a tag may identify itself as a device to be used for calibration in transmitted DF packets. The FnD device may be configured to automatically identify and select this tag as the calibration source by reading information contained in these DF packets. Then, during the calibration process hereinafter, the direction-finding system of the FnD device will not process those signals which come from other tag IDs then the determined calibration source/tag.

After that, at step 702, the FnD device can take a photo of the confirmed tag in the UI indicator (central marker) and store the image of the calibration source in its memory. To make visual tracking of the tag in the subsequent calibration process easily, the surface of the tag may be as colorful or vivid as possible.

Then, at step 703, an instruction packet (i.e., a calibration request) may be sent from the FnD device through one antenna of its antenna array to the calibration source. The calibration request is to make the calibration source enter a calibration mode where the calibration source is configured to transmit signals (DF packet) at a higher rate than in a normal mode. For example, the tag will transmit one DF packet per second in the normal mode, while the tag will transmit five DF packets per second in the calibration mode. Such a calibration mode can improve the calibration accuracy and shorten the calibration time.

In some further embodiments, the calibration request may include some parameters relating to the rate of transmitting DF packet in the calibration mode. For example, the calibration request may include an indicator indicating high, medium, or low grade of calibration accuracy, which corresponds to a high, medium, or low rate of transmitting DF packets. The calibration tag can adjust its transmitting according to the received calibration request.

After the initialization procedures, the calibration starts. In following process, the user rotates and/or moves and/or orientates the FnD device to let the visual image of the calibration tag on the screen fall in different points, meanwhile the FnD device records response data (DF packet) received from the calibration tag and corresponding calculated orientation angle in the memory. The pre-stored image of the calibration tag in the initialization phase is used to calculate the orientation angles between the FnD device and the calibration tag by processing image/video of camera real-time replay in the calibration process.

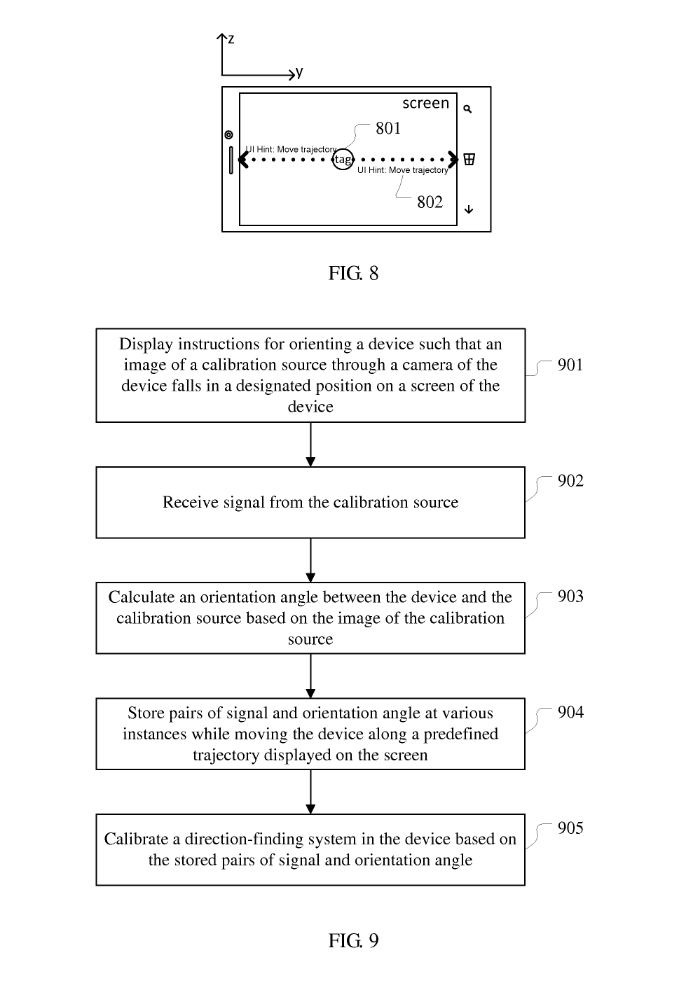

The FnD device may prompt the user to initiate device movement. An example of a user interface movement prompt and device movement in accordance with at least one embodiment of the present invention is disclosed in FIG. 8.

As shown in FIG. 8, the user interface has drawn a UI indicator 802, which is a dotted line across the screen from left to right or some other predefined trajectory, and prompts the user to orient/rotate the FnD device to let the visual image 801 of the calibration tag traverse the trajectory on the screen. The traversal may be from the center to the left end, then to the right end, and then back to the center. The traversal can be performed for several rounds in order to improve the accuracy of the calibration. During the traversal of the trajectory or after that, process may be performed on the response data received from the calibration tag, in order to provide calibration values matched with the direction-finding system of the FnD device, which will be described later.

FIG. 9 is a flow chart schematically illustrating a calibration method according to an embodiment of the present invention.

At step 901, the FnD device displays instructions (e.g., the move trajectory 802 in FIG. 8) for orienting the FnD device such that the visual image of the calibration source through the camera of the FnD device falls in a designated position (i.e., along the move trajectory) on the screen.

At step 902, the FnD device receives a signal (DF packet) from the calibration tag via the antenna array of the FnD device. When the FnD device is moved, the signal or response data (i.e., DF packet) for the antenna array will change due to the change in orientation for the antenna array with respect to the fixed origin direction of the calibration tag.

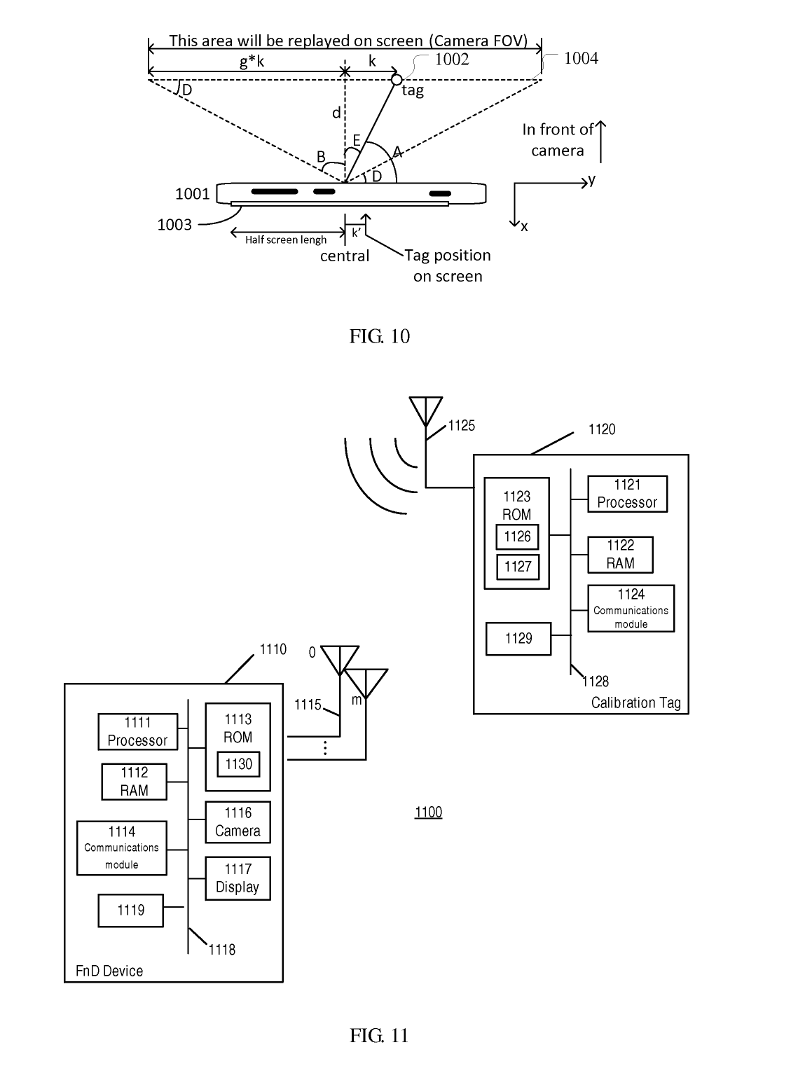

At step 903, during the movement of the FnD device, the FnD device may calculate an orientation angle between the FnD device and the calibration source based on the visual image of the calibration source on the screen. The calculation of the orientation angle can be based on the location of the visual image of the calibration tag on the screen. The location can be derived from image recognition based on the pre-stored image of the calibration tag. The detailed calculation of the orientation angel will be described later with respect to FIG. 10.

Then, at step 904, the FnD device may store pairs of the signal and the orientation angle at various instances while moving the FnD device along the predefined trajectory displayed on the screen. In other words, the response data are recorded paired with corresponding angle between the FnD device and the calibration tag. In some embodiments, there will be one record per DF packet. Depending on the time of the data processing (such as averaging, interpolation, etc.) on the response data, part or all response data are recorded. As mentioned previously, the data processing may be carried out along with the movement of the FnD Device, or after the movement of the FnD device. When the latter is adopted, all response data and corresponding angles are stored during the movement.

Finally, at step 905, the FnD can calibrate the direction-finding system therein based on the stored pairs of the signal and the orientation angle.

Usually the direction-finding algorithm of the direction finding system has some assumption on the response data for the antenna array. For example, an algorithm assumes that angles corresponding to response data are uniformly distributed in a range of 30˜150 degree. That means corresponding angels A1, A2, A3, . . . AN of response data C1, C2, C3, . . . CN are 30+0, 30+(120/N), 30+(2*120/N), . . . 30+((N−1)*120/N) degree. That is, normally, a reference matrix for the direction-finding algorithm may already be loaded onto the FnD device, and the calibration process may be utilized as a technique for correcting the reference matrix recorded for the antenna array when, for example, the reference matrix is determined to be out-of-calibration. Thus, in some further embodiments, the calibration further comprises creating a matrix of calibration values using the stored pairs of the signal and the orientation angle. The created matrix comprises calibration signals which correspond to a set of designated orientation angles (e.g., A1, A2, A3, . . . AN) and are generated from the stored pairs of the signal and the orientation angle. Embodiments of the present invention have provided two exemplary processing methods for creating the matrix to make calibration aligned with the above angle assumption.

A first method is to record only those response data when the calibration tag is in angle A1, A2, A3, . . . AN. In addition, those response data corresponding to the same angle in different rounds of the traversal of the predefined trajectory may be averaged to improve calibration accuracy.

A second method is to record response data of all angles during the movement of the FnD device. Interpolation is used to get response data in target angle A1, A2, A3, . . . AN. Interpolation may be ‘nearest’, ‘linear’, ‘cubic’, ‘FFT (Fast Fourier Transformation)’, ‘EADF (Effective Aperture Distribution Function)’, ‘SHT (Spherical Harmonic Transformation)’, etc. Also, those response data corresponding to the same angle in different rounds of the traversal of the predefined trajectory may be averaged to improve calibration accuracy.

Additionally, during the movement of the FnD device, the FnD device tracks an actual moving trajectory of the visual image of the calibration source on the screen by using the pre-stored image of the calibration source. The FnD device thus checks whether the actual moving trajectory on the screen is too far away from the predefined trajectory on the screen. For example, the FnD device checks whether a distance from the actual moving trajectory to the predefined trajectory exceeds a distance threshold. In response to the distance exceeding the distance threshold, the FnD device would provide an alert. In some implementations, the alert could be implemented as audible, visible, and/or tactile signal. For example, a text box or a bulls-eye target can be shown to prompt a user of the device, or the form, size or color of the predefined trajectory and/or the actual moving trajectory could be changed in some ways to prompt the user of the device. Alternatively or additionally, a beeping sound or vibration could be provided. The user interface could give some hints, such as blinking the predefined trajectory into another color on screen or some sounds through a speaker. If the visual image of the calibration tag is back to close enough area to the predefined trajectory, the predefined trajectory will be recovered to its normal state. Those skilled in the art could appreciate that, other types of hints may be given to the user, and the invention is not limited in this aspect.

Additionally, during the movement of the FnD device, the FnD device may check whether a moving speed of the calibration source image exceeds a speed threshold. In response to the moving speed exceeding the speed threshold, the FnD device would provide an alert. Similarly, this alert could also be implemented as audible, visible, and/or tactile signal. The moving speed can be evaluated by degree/second. If the moving speed is too high, another hint may be displayed on the screen, for example some text on the screen, or by a speaker.

FIG. 10 schematically shows the principle of camera field-of-view (FOV) based angle calculation according to embodiments of the present invention.

As shown in FIG. 10, a coordinate system (X-Y) is established based on the FnD device 1001. The FnD device 1001 is oriented to face its camera towards front, and the calibration tag 1002 in a direction which the user wants to calculate by its image location on the screen. The visual image of the calibration tag 1002 through the camera is displayed in real time on the screen 1003 of the FnD device 1001. The orientation angle between the FnD device 1001 and the calibration tag 1002 is denoted by angle A. As can be seen, the angle A will be in a range of D to pi-D, where D is an angle associated with the camera FOV. Thus, the problem is to solve angle A based on the visual image of the calibration tag on the screen 1003.

In the calculation, it is assumed that camera FOV is a pre-known parameter to the calibration process (this is easy to know for a device company). This means that angle D and angle B in FIG. 10 are pre-known. Further, it is a reasonable assumption that the position (e.g., denoted by k in FIG. 10) of the calibration tag 1002 in the focus plane 1004 of the real world is linearly proportional to the position (e.g., denoted by k′ in FIG. 10) of the visual image of the calibration tag 1002 on the screen.

Though the value of k is unknown in the calibration process because the distance d (which is the distance from the calibration tag 1002 to the surface of the screen 1003) is unknown, the value of g can be measured on screen. The parameter g indicates the ratio of the half length of the focus plane 1004 to the position k of calibration tag 1002 in the real world, and also indicates the ratio of the half length of the screen 1003 to the position k′ of calibration tag 1002 on the screen. The measurement of g will be described later.

Hereinafter, the calculation method will be detailed, in which all angles are in radian. According to the above assumptions, because angle D is pre-known, thus it can be derived that:

g*k/d=tan(B) (1).

From the above equation (1), it can be further derived that:

k/d=tan(B)/g (2).

Then, angle E can be calculated by:

E=arctan(k/d)=arctan(tan(B)/g) (3).

Because angle B and g are known, angle E can be calculated now.

Then, the interested angle A can be calculated by:

A=(pi/2)−E,

if the calibration tag falls in right half of the screen;

A=(pi/2)+E,

if the calibration tag falls in left half of the screen.

As mentioned above, the parameter g also indicates the ratio of the half length of the screen 1003 to the position k′ of calibration tag 1002 on the screen. Thus, the value of g can be measured on the screen 1003 by dividing ‘half screen length’ by k′, where k′ is the distance on the screen from visual tag to the central point of the screen. Because the visual image of the calibration tag is continuously tracked by image recognition based on the pre-stored image of the calibration tag in the initialization phase, the distance k′ may be easily measured in how many pixels from the visual image of the calibration tag to the central point of the screen. And the ‘half screen length’ may also be in pixels. Thus dividing ‘half screen length’ by k′ makes sense.

The assumption, which is that the position of the calibration tag in the focus plane 1004 of the real world is linearly proportional to the position of the visual image of the calibration tag on the screen, may not kept strictly for some special lens, such as fisheye lens. However, this can be compensated by camera software for those engineers in imaging processing field. Those compensation methods are known in the art, and the description thereof is omitted here.

The central point of the screen 1003 is actually mapped to the center of camera lens. The center of camera lens may not be in the same location of the antenna array center. However, for the FnD application, the distance from the FnD device to an object to be found is much bigger than this center difference in most cases, and this leads to very little effect and thus this non-ideal factor can be omitted.

Thus the above have described a camera based calibration mechanism for embodiments of the present invention. The proposed user-executable calibration only uses a camera of the device as a sensor to get or calculate the orientation angle. It needn't any other sensor (such as accelerometer, gyro) to sense attitude and/or direction and/or distance. It only use a user interface (UI) to guide a consumer completing the whole process no matter how the consumer holds/rotates/moves/orientates the device. The proposed calibration is performed without returning to factory. Moreover, the calibration is performed without high accuracy mechanical equipment or robot, which is usually used in the chamber measurement.

In the above description, a one-dimensional (1-D) calibration method is given as an example, i.e., 1-D move trajectory on the screen, and this is corresponding to azimuth only FnD mode. For the FnD which supports not only azimuth angle but also elevation angle, the move trajectory in the up-down direction on the screen may be added, and a two-dimensional (2-D) calibration method can be derived easily based on this 1-D calibration example.

For example, the move trajectory on the screen may be comprised of several parallel horizontal lines, which are spaced by a fixed interval corresponding to a certain elevation angle. Alternatively, the move trajectory on the screen may be comprised of several parallel vertical lines, which are spaced by a fixed interval corresponding to a certain azimuth angle. As another option, the move trajectory on the screen may be a cross comprised of a horizontal line and a vertical line. In the 2-D direction-finding system, the orientation angle between the FnD device and the object (or tag) can include an azimuth angle and an elevation angle. The detailed calibration method can be derived easily from the 1-D calibration method, and the description thereof is omitted here.

As described previously, in one scenario, the calibration source may be a low-power device supplied to the user along with the FnD device to be utilized specifically for calibration. FIG. 11 shows such a system in which one or more embodiment according to the present invention can be implemented.

As shown in FIG. 11, the system 1100 includes an FnD device 1110 and a calibration tag 1120. The calibration tag 1120 can be stand-alone or inside device or other asset. The calibration tag 1120 is able to transmit direction-finding (DF) packet. The DF packets may be transmitted periodically from the calibration tag 1120 to the FnD device 1110. More specifically, the calibration tag 1120 may have a calibration mode where DF packets are transmitted more frequently then in a normal mode.

The FnD device 1110 comprises at least a processor 1111. The processor 1111 is connected to volatile memory such as RAM 1112 by a bus 1118. The bus 1118 also connects the processor 1111 and the RAM 1112 to non-volatile memory such as ROM 1113. The FnD device 1110 also comprises a communications module 1114. The communications module 1114 incorporates all of the communications aspects of the FnD device 1110, for example long-range communications such as GSM, WCDMA, GPRS, WiMAX, etc., short-range communications such as Bluetooth™, WLAN, UWB, WUSB, Zigbee, UHF RFID, etc., and machine-readable communications such as RFID, infra-Red (IR), Bar Code, etc. The communications module 1114 is coupled to the bus 1118, and thus also to the processor 1111 and the memories 1112, 1113. An antenna array 1115 is coupled to the communications module 1114. Also connected to the bus 1118 are a camera 1116 and a display 1117, such as a touchable screen. Within the ROM 1113 is stored a software application 1130. The software application 1130 in these embodiments is a direction-finding application, although it may take some other form. Of course, the FnD device 1110 also comprises a number of components which are indicated together at 1119. These components 1119 may include any suitable combination of a user input interface, a speaker, and a microphone, etc. The components 1119 may be arranged in any suitable way. Details can be referred to the description with reference to FIG. 3.

The calibration tag 1120 comprises at least a processor 1121. The processor 1121 is connected to volatile memory such as RAM 1122 by a bus 1128. The bus 1128 also connects the processor 1121 and the RAM 1122 to non-volatile memory such as ROM 1123. The calibration tag 1120 also comprises a communications module 1124, for example short-range communications such as Bluetooth™, WLAN, UWB, WUSB, Zigbee, UHF RFID, etc. The communications module 1124 is coupled to the bus 1128, and thus also to the processor 1121 and the memories 1122, 1123. An antenna 1125 is coupled to the communications module 1124. Within the ROM 1123 is stored a software application 1126. The software application 1126 in these embodiments is a calibration application, although it may take some other form. The ROM 1123 also stores information 1127. The information 1127 may include an identifier that identifies the tag 1120. Of course, the tag 1120 may also comprises a number of components which are indicated together at 1129. These components 1129 may include any suitable combination of a user input interface, a speaker, and a microphone, etc. The components 1129 may be arranged in any suitable way.

The communications modules 1114 and 1124 may take any suitable form. Generally speaking, the communications modules 1114 and 1124 may comprise processing circuitry, including one or more processors, and a storage device comprising a single memory unit or a plurality of memory units. The storage device may store computer program instructions that, when loaded into the processing circuitry, control the operation of the communications modules 1114 and 1124.

Typically, the communications modules 1114, 1124 each comprise a processor coupled to both volatile memory and non-volatile memory. The computer program is stored in the non-volatile memory and is executed by the processor using the volatile memory for temporary storage of data or data and instructions.

Each communications module 1114, 1124 may be a single integrated circuit. Each may alternatively be provided as a set of integrated circuits (i.e. a chipset). The communications modules 1114, 1124 may alternatively be hardwired, application-specific integrated circuits (ASIC).

Computer program instructions stored in the ROM 1113, 1123 may provide the logic and routines that enables the FnD device 1110 and the calibration tag 1120 to perform the functionality described above with respect to FIGS. 4-10, respectively.

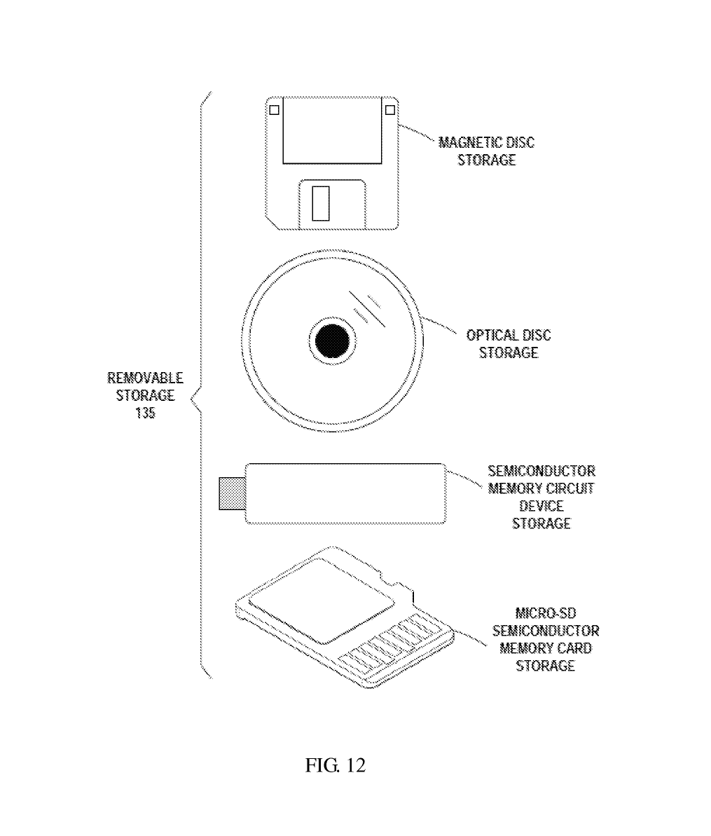

Alternatively, the computer program instructions may arrive at the FnD device 1110 and/or the tag 1120 via an electromagnetic carrier signal or be copied from a physical entity such as a computer program product, a non-volatile electronic memory device (e.g. flash memory) or a storage medium 135 as shown in FIG. 12, such as a magnetic disc storage, optical disc storage, semiconductor memory circuit device storage, micro-SD semiconductor memory card storage. They may for instance be downloaded to the FnD device 1110 and the tag 1120 from a server such as a server of an application marketplace or store.

The processor 1111, 1121 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 1111, 1121 may be termed processing means.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-18. (canceled)

19. A method, comprising:
displaying instructions for orienting a device such that an image of a calibration source through a camera of the device falls in a designated position on a screen of said device;
receiving a signal from said calibration source via an antenna array of the device;
calculating an orientation angle between said device and said calibration source based on said image of the calibration source;
storing pairs of the signal and the orientation angle at various instances while moving or rotating the device to make the image of the calibration source move along a predefined trajectory displayed on the screen; and
calibrating a direction-finding system in the device based on the stored pairs of the signal and the orientation angle.

20. The method of claim 19, further comprising an initialization process which includes:
determining said calibration source;
storing an image of said calibration source; and
sending a calibration request to said calibration source, to make the calibration source enter a calibration mode where the calibration source transmits the signal at a high rate.

21. The method of claim 19, wherein calibrating a direction-finding system in the device based on the stored signals and angles comprising:
creating a matrix of calibration values in the device using the stored pairs of the signal and the orientation angle, said matrix comprising calibration signals which correspond to a set of designated orientation angles and are generated from the stored pairs of the signal and the orientation angle.

22. The method of claim 19, further comprising:
during moving or rotating the device, tracking an actual moving trajectory of the image of the calibration source on the screen by using a pre-stored image of the calibration source;
checking whether a distance from the actual moving trajectory to the predefined trajectory exceeds a distance threshold; and
in response to the distance exceeding the distance threshold, providing an alert.

23. The method of claim 19, further comprising:
during moving or rotating the device, checking whether a moving speed of the image of the calibration source exceeds a speed threshold; and
in response to the moving speed exceeding the speed threshold, providing an alert.

24. The method of claim 19, further comprising checking whether the device needs calibration by:
displaying a real-time position of a signal source on the screen through the camera;
marking a calculated position of the signal source on the screen, said calculated position being determined by the direction-finding system of the device based on a signal received from the signal source via the antenna array; and
in response to an offset between the real-time position and the calculated position exceeding an offset threshold, deciding that the device needs calibration.

25. The method of claim 19, wherein said predefined trajectory includes one-dimensional trajectory or two-dimensional trajectory, and said orientation angle includes at least one of an azimuth angle and an elevation angle.

26. An apparatus, comprising:
at least one processor; and
at least one memory including computer program code,
wherein the at least one memory and the computer program code configured to, with the at least one processor, cause the apparatus at least to:
display instructions for orienting a device such that an image of a calibration source through a camera of the device falls in a designated position on a screen of said device;
receive a signal from said calibration source via an antenna array of the device;
calculate an orientation angle between said device and said calibration source based on said image of the calibration source;
store pairs of the signal and the orientation angle at various instances while moving or rotating the device to make the image of the calibration source move along a predefined trajectory displayed on the screen; and
calibrate a direction-finding system in the device based on the stored pairs of the signal and the orientation angle.

27. The apparatus of claim 26, wherein the apparatus is further caused to perform an initialization process which includes:
determining said calibration source;
storing an image of said calibration source; and
sending a calibration request to said calibration source, to make the calibration source enter a calibration mode where the calibration source transmits the signal at a high rate.

28. The apparatus of claim 26, wherein the apparatus is further caused to calibrate a direction-finding system in the device based on the stored signals and angles by:
creating a matrix of calibration values in the device using the stored pairs of the signals and the orientation angles, said matrix comprising calibration signals which correspond to a set of designated orientation angles and are generated from the stored pairs of the signals and the orientation angles.

29. The apparatus of claim 26, wherein the apparatus is further caused to:
during moving or rotating the device, track an actual moving trajectory of the image of the calibration source on the screen by using a pre-stored image of the calibration source;
check whether a distance from the actual moving trajectory to the predefined trajectory exceeds a distance threshold; and
in response to the distance exceeding the distance threshold, provide an alert.

30. The apparatus of claim 26, the apparatus is further caused to:
during moving or rotating the device, check whether a moving speed of the image of the calibration source exceeds a speed threshold; and
in response to the moving speed exceeding the speed threshold, provide an alert.

31. The apparatus of claim 26, the apparatus is further caused to check whether the device needs calibration by:
displaying a real-time position of a signal source on the screen through the camera;
marking a calculated position of the signal source on the screen, said calculated position being determined by the direction-finding system of the device based on a signal received from the signal source via the antenna array; and
in response to an offset between the real-time position and the calculated position exceeding an offset threshold, deciding that the device needs calibration.

32. The apparatus of claim 26, wherein said predefined trajectory includes one-dimensional trajectory or two-dimensional trajectory, and said orientation angle includes at least one of an azimuth angle and an elevation angle.

33. A non-transitory computer readable medium with computer program code stored thereon, the computer program code causing an apparatus to perform the following when executed by a processor:
displaying instructions for orienting a device such that an image of a calibration source through a camera of the device falls in a designated position on a screen of said device;
receiving a signal from said calibration source via an antenna array of the device;
calculating an orientation angle between said device and said calibration source based on said image of the calibration source;
storing pairs of the signal and the orientation angle at various instances while moving or rotating the device to make the image of the calibration source move along a predefined trajectory displayed on the screen; and
calibrating a direction-finding system in the device based on the stored pairs of the signal and the orientation angle.

34. The computer readable medium of claim 33, the computer program code stored thereon further causing the apparatus to perform, when executed by the processor, an initialization process which includes:
determining said calibration source;
storing an image of said calibration source; and
sending a calibration request to said calibration source, to make the calibration source enter a calibration mode where the calibration source transmits the signal at a high rate.

35. The computer readable medium of claim 33, wherein calibrating a direction-finding system in the device based on the stored signals and angles comprising:
creating a matrix of calibration values in the device using the stored pairs of the signal and the orientation angle, said matrix comprising calibration signals which correspond to a set of designated orientation angles and are generated from the stored pairs of the signal and the orientation angle.

36. The computer readable medium of claim 33, the computer program code stored thereon further causing the apparatus to perform the following when executed by the processor:
during moving or rotating the device, tracking an actual moving trajectory of the image of the calibration source on the screen by using a pre-stored image of the calibration source;
checking whether a distance from the actual moving trajectory to the predefined trajectory exceeds a distance threshold; and
in response to the distance exceeding the distance threshold, providing an alert.

37. The computer readable medium of claim 33, the computer program code stored thereon further causing the apparatus to perform the following when executed by the processor:
during moving or rotating the device, checking whether a moving speed of the image of the calibration source exceeds a speed threshold; and
in response to the moving speed exceeding the speed threshold, providing an alert.

38. The computer readable medium of claim 33, the computer program code stored thereon further causing the apparatus to perform the following when executed by the processor:
checking whether the device needs calibration by:
displaying a real-time position of a signal source on the screen through the camera;
marking a calculated position of the signal source on the screen, said calculated position being determined by the direction-finding system of the device based on a signal received from the signal source via the antenna array; and
in response to an offset between the real-time position and the calculated position exceeding an offset threshold, deciding that the device needs calibration.
